(19) United States
(12) Patent Application Publication
(10) Pub. No.: US 2012/0194266 A1
(43) Pub. Date: Aug. 2, 2012

(54) Reduction of the Sensitivity to the Jitter Demodulation of the Sampling Clock Signal

(76) Inventor: Philippe Galdemard, La Celle les Bordes (FR)

(21) Appl. No.: 13/383,979

(22) PCT Filed: Jul. 13, 2010
(86) PCT No.: PCT/FR2010/000505

§ 371 Date: Mar. 29, 2012

(30) Foreign Application Priority Data
Jul. 15, 2009 (FR) 09/03455

(51) Int. Cl. H04L 27/38

(52) U.S. Cl. 329/304

(57) ABSTRACT

The invention relates to a method for the demodulation of a radiofrequency signal (Y), that comprises the steps of: providing a synchronous sampling clock signal (HE) of said radiofrequency signal to be demodulated; sampling said radiofrequency signal using said sampling clock signal; and processing the samples thus obtained in order to determine the phase and/or amplitude of said radiofrequency signal; characterized in that it further comprises the step of adjusting the phase, as measured relative to the sampling clock signal, of said signal to be demodulated and/or of a synchronous reference signal (R) relative to which the signal is demodulated in order to minimize the phase and/or amplitude error generated by a jitter of said sampling clock signal. The invention also relates to a demodulator circuit for implementing said method.

The invention relates to a method and to a circuit for demodulating a radiofrequency signal, serving to determine phase and/or amplitude information about said signal. The invention presents numerous potential applications, in particular in the field of particle accelerators, but also in the field of telecommunications.

The processing of signals that modulate a radiofrequency (RF) carrier by means of digital systems such as processors, field programmable gate arrays (FPGAs), etc. requires, upstream from such systems, a system for receiving and acquiring signals. The conversion of an analog signal at radiofrequency into data that can be used by the processor or the FPGA is normally performed by using one or more analog-to-digital converters (ADCs), possibly after transposing the analog signal to an intermediate frequency (IF) that is lower. Once the frequency of the sampled signal is fairly high, the jitter of the sampling clock that actuates the sample-and-hold circuit becomes a major source of noise in the measurements. In this context, reference may be made to document [1].

In particular, in order to simplify the electronics for acquiring the RF signals, it is sometimes desirable to sample the RF signal directly without any frequency translation. In addition to representing an extra cost, a frequency translation stage is difficult to implement and gives rise to signal distortion and to additional noise. For such systems for which it is desired to eliminate the frequency translation stage, direct sampling requires analog signals to be sampled at high frequency, where the jitter of the sampling clock becomes a major source of noise and limits measurement accuracy.

Clock signal jitter is the random difference in the times of arrival of the fronts in said signal compared with an ideal clock having the same frequency. For all systems that sample a signal that varies relatively quickly in time, such as a radiofrequency signal, sampling clock jitter gives rise to a measurement error that is significant and random, and that increases with increasing speed in the variation of the sampled signal, and is thus all the more troublesome when the frequency of the sampled analog signal is high.

Numerous devices have been studied or developed for reducing clock signal jitter, not only because it limits the accuracy of analog-to-digital converters operating on analog signals of high frequency, but above all because it limits the operating frequency of digital logic circuits. Among the most popular devices, there are phase-locked loops (PLLs) that may even be included in the functions provided by complex integrated circuits such as FPGAs.

Chapter 1 of document [2] describes the effect of the jitter of a sampling clock and the use of a PLL or of a dedicated circuit (jitter-attenuation circuit) for reducing said jitter. Unfortunately, the best presently-available digital circuits, based on a PLL or some other technique, produce clocks in which the root mean square (rms) jitter is at best a few picoseconds (ps). For example, the jitter is about 20 ps rms for the Xilins Virtex-5 FPGA.

For digital systems that require very great accuracy when measuring the phase of an RF signal, a clock with such jitter cannot be used for sampling the signal directly, once the RF frequency is fairly high. For example, in a particle accelerator having an operating frequency of 1 gigahertz (GHz), a clock jitter of 20 ps rms would limit the raw phase measurement of the RF signal as performed by direct in-phase and quadrature (IQ) sampling to about 7° rms, whereas the specification for phase regulation in such accelerators is rather of the order of ±1°, or even much less. As another example, mention may be made of the future XFEL accelerator for which the stability required of the RF fields at 1.3 GHz is of the order of 0.01° in phase and of 0.01% in amplitude (see document [3]).

In present devices, in order to improve accuracy in the measurement of RF signals, recourse is had to one or more of the following technical solutions, that may be used simultaneously, where appropriate:

1) using a low-jitter clock, when that can be implemented;

2) having recourse to a mixer device, that enables the signal to be transposed to an intermediate frequency that is lower; and/or

3) calculating the time average over a certain number of successive samples in order to improve the signal-to-noise ratio.

In general, solution 1) implies that the clock is synthesized outside the digital components used for implementing the RF electronic cards that perform signal acquisition and processing. That solution therefore requires additional components that are not necessarily easy to integrate with such electronic cards. That is a solution that has been adopted for enabling RF voltages at 88 megahertz (MHz) to be sampled directly in the Spiral-2 project (see document [4]).

Solution 2) is commonly used in particle accelerators. Frequency translation makes it possible to create an analog signal of intermediate frequency that is much lower than the frequency of the original RF signal, but that conserves all of the amplitude and phase information in said signal. However the frequency translation stage is a device that is difficult to implement, expensive, sensitive to temperature, and that generates additional noise and interfering harmonics. The use of this solution in particle accelerator is also associated with the fact that analog-to-digital converters having sufficient resolution (12-14 bits) have for a long time presented an analog passband that is too narrow compared with the operating frequency of accelerators. This is changing with the appearance on the market of 14-bit coders having an analog passband of more than 1 GHz (e.g.: Analog Devices ADC14DS105, or Texas Instruments ADS5474).

Solution 3) which may be implemented technically in various different ways (see for example document [5]), can be implemented only when the time available for taking the measurement makes this possible. In accelerators, that technique is sometimes used, but its contribution is limited by the small latency time that is acceptable for RF regulation loops, thereby limiting the number of samples that can be averaged. Furthermore, the noise due to conversion clock jitter is not white noise, so the improvement of the signal-to-noise ratio by averaging N samples is generally much less than the factor of \sqrt{N} that is to be expected with white noise.

The invention seeks to provide a method and a circuit for demodulating a radiofrequency signal that does not present the above-mentioned drawbacks of the prior art. The invention is based on the well-known techniques of IQ and of non-IQ sampling, and it stems from the discovery that the sensitivity of those techniques to jitter of the sampling clock signal depends strongly on the phase of the radiofrequency signal. The invention applies in particular to demodulating signals in which the carrier, possibly after frequency conversion, presents a frequency that is relatively high, of the order of 100 MHz or more, indeed greater than or equal to 1 GHz.

In one aspect, the invention thus provides a method of demodulating a radiofrequency signal, the method comprising the steps consisting in:
providing a sampling clock signal that is synchronous with said radiofrequency signal for demodulating;
sampling said radiofrequency signal by means of said sampling clock signal; and
processing the samples obtained in this way to determine the phase and/or the amplitude of said radiofrequency signal;

the method being characterized in that it also includes a step of adjusting the phase, measured relative to the sampling clock signal, of said signal for demodulating and/or of a synchronous reference signal relative to which said signal is demodulated, in such a manner as to minimize the phase and/or amplitude error caused by jitter of said signal clock signal.

In particular implementations of the method of the invention:
Said radiofrequency signal may present a carrier at the frequency f_{RF} while said sampling clock signal presents a frequency f_{S}=N₁/N₂·f_{RF} where N₁ and N₂ are different natural integers such that there does not exist any non-zero natural integer N₃ for which N₁/N₂=2/N₃ (in other words, such that the period of the sampling signal is not a multiple of the half-period of the signal for sampling).
In particular, said sampling clock signal may present a frequency f_{S}=4/(2k+1)·f_{RF}, where k is a natural integer, whereby said sampling is IQ-type sampling.
In a variant, said sampling clock signal may present a frequency f_{S}=N₁/N₂·f_{RF}≠4(2k+1)·f_{RF} where k is a natural integer, whereby said sampling is non-IQ type sampling.
Advantageously, the phase of said radiofrequency signal as measured relative to the sampling signal may be adjusted to a value that is as close as possible to a target value selected from:
   ±kπ/2 for integer k, so as to minimize the amplitude measurement error caused by jitter of said sampling clock signal; and
   π/4±kπ/2 for integer k, so as to minimize the phase measurement error caused by the jitter of said sampling clock signal.

In general, the target value cannot be reached exactly because of inevitable calibration errors and also, when phase is adjusted by using a digital phase shifter, because of the finite resolution of such a phase shifter.
The method may comprise IQ sampling of said radiofrequency signal that is referred to as the main signal, and of a second radiofrequency signal that is synchronous with said main signal and that is referred to as the reference signal, and processing samples as obtained in this way to determine the phase variations of said main signal relative to said reference signal, wherein the phase φ_{RF} of the carrier of said main signal and the phase φ_{REF} of said reference signal are adjusted in such a manner as to minimize the error in the measurement of:

$$( {ϕ}_{RF} - \frac{{f}_{RF}}{{f}_{REF}} {ϕ}_{REF} )$$

where f_{REF} is the frequency of the reference signal, which frequency is commensurable with the frequency of the main signal.
Advantageously, the phase φ_{RF} of said main signal and the phase φ_{REF} of said reference signal may be adjusted in such a manner as to come as close as possible to the relationship φ_{REF}=±φ_{RF}+kπ with integer k, the phase φ_{RF} of said main signal and the phase φ_{REF} of said reference signal may be adjusted in such a manner as to come as close as possible to the following relationships:

φ_{RF}=±kπ/2

and

φ_{REF}=±φ_{RF}±k′π

with integer k and k′. In general, these relationships cannot be satisfied exactly because of inevitable calibration errors, and also, when the phases are adjusted by using one or more digital phase shifters, because of the finite resolution of such phase shifter(s).
In a variant, the method may include non-IQ sampling of a first radiofrequency signal that is referred to as the main signal, and of a second radiofrequency signal that is synchronous with said main signal and that is referred to as the reference signal, and processing samples as obtained in this way to determine the phase variations of said main signal relative to said reference signal, wherein the phase φ_{RF} of the carrier of said main signal and the phase φ_{REF} of said reference signal are adjusted in such a manner as to minimize the error in the measurement of the magnitude:

$$( {ϕ}_{RF} - \frac{{f}_{RF}}{{f}_{REF}} {ϕ}_{REF} )$$

where f_{REF} is the frequency of the reference signal, which frequency is commensurable with the frequency of the main signal.

In particular, the phase φ_{RF} of said main signal and the phase φ_{REF} of said reference signal may be adjusted in such a manner as to come as close as possible to the relationship φ_{REF}=±φ_{RF}+±kπ with integer k. Once more, in general, this relationship cannot be satisfied exactly because of inevitable calibration errors, and also, when the phases are adjusted by using one or more digital phase shifters, because of the finite resolution of the phase shifter(s).
The carrier of said main signal and said reference signal may be at the same frequency. In a variant, these signals may be synchronous, i.e. they may present frequencies that are commensurable (that have a rational ratio), but that are in general different.
Said phase adjustment may be obtained by means of at least one phase shifter. In particular, said phase adjustment may be obtained by means of at least two phase shifters for introducing independent phase shifts of said main signal and of said reference signal.

In another aspect, the invention provides a demodulator circuit comprising: a first input for a radiofrequency signal for demodulating; a generator for generating a sampling clock signal that is synchronous with said radiofrequency signal; a first sampler for sampling said radiofrequency signal under the control of said sampling clock signal; and processor means for processing samples as obtained in this way in order to determine the phase and/or the amplitude of said radiofrequency signal; said circuit being characterized in that it includes at least one adjustable phase shifter for shifting said radiofrequency signal, a synchronous reference signal relative to which said signal is demodulated, and/or said sampling clock signal.

Advantageously, such a circuit may include an input for a second radiofrequency signal referred to as the reference signal; and a second sampler controlled by said sampling clock signal in order to sample said reference signal; said sample processor means being adapted to determine phase information relating to said main signal relative to said reference signal on the basis of samples provided by said first and second samplers. Said sampling clock signal generator may be controlled by said reference signal.

The circuit of the invention may also include control means for adjusting said or each phase shifter in such a manner as to maintain the phase and/or the phase difference of said main signal and of said reference signal within a predetermined range of values.

Advantageously, the circuit may include at least two phase shifters arranged to introduce independent phase shifts of said main signal and of said reference signal.

Other characteristics, details, and advantages of the invention appear on reading the following description made with reference to the accompanying drawings given by way of example, and in which:

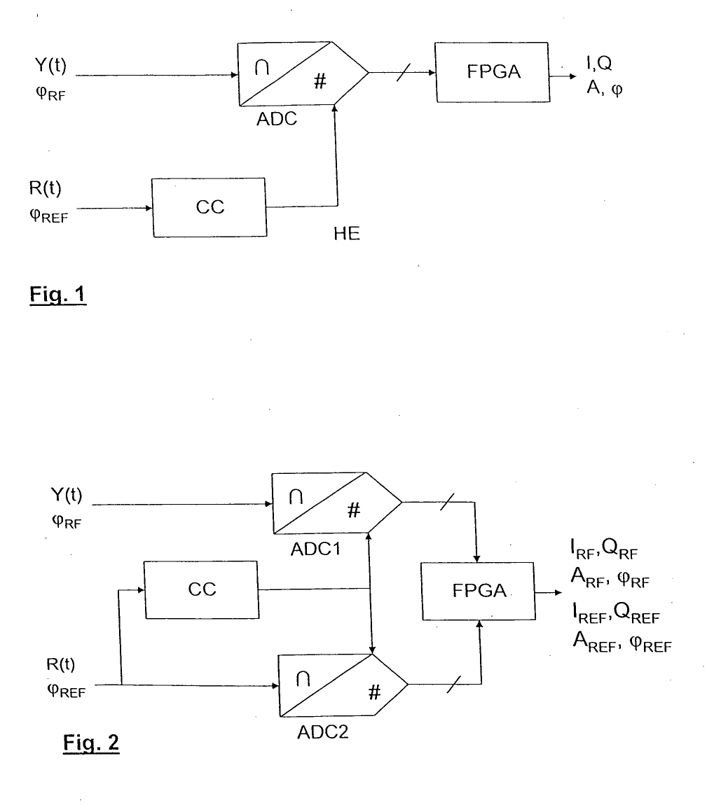

FIG. 1 is a diagram showing the principle of a known demodulator circuit of the prior art, based on single IQ sampling;

FIG. 2 is a diagram showing the principle of a known demodulator circuit of the prior art, based on double IQ sampling;

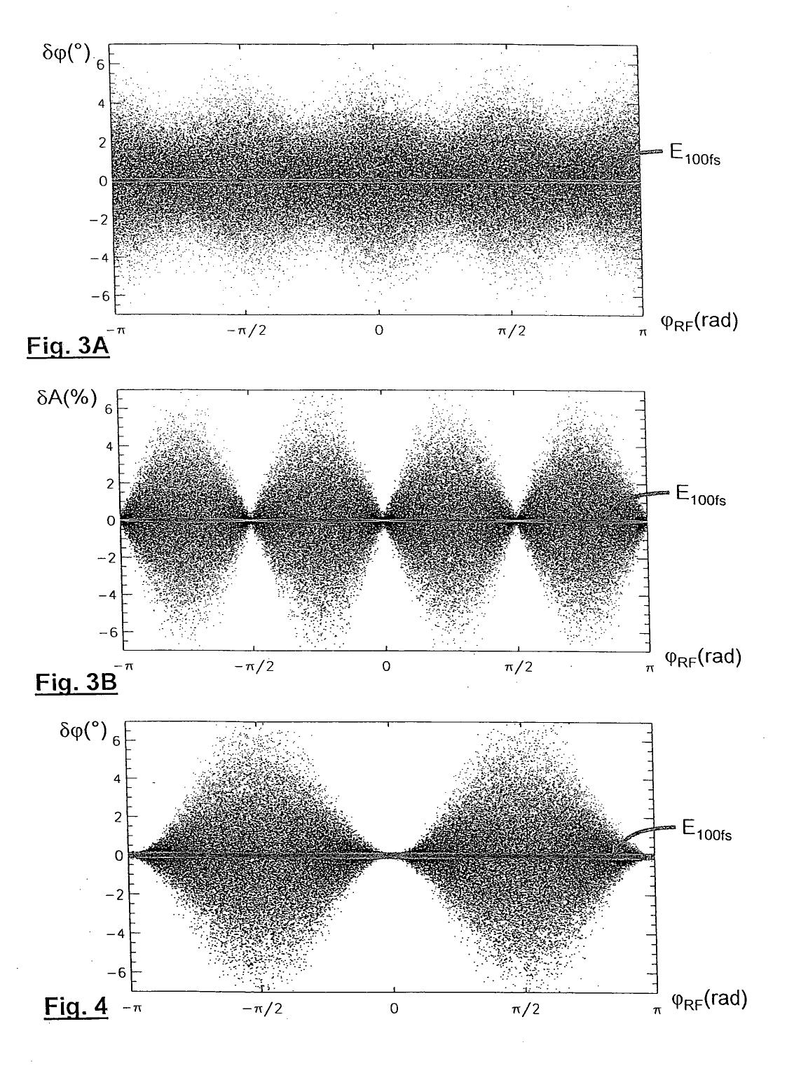

FIGS. 3A, 3B, and 4 to 7 are graphs showing the influence of the phase of the radiofrequency signal, and in FIGS. 4 to 7, of the reference signal, on the phase/amplitude measurement error introduced by jitter; and

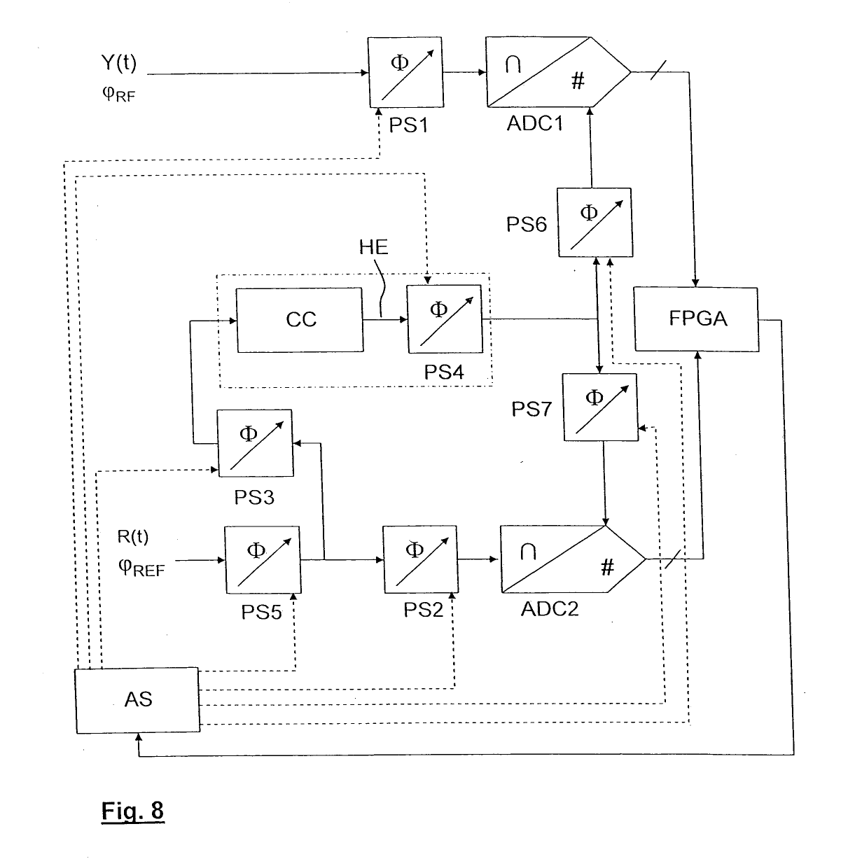

FIGS. 8 to 11 are diagrams showing the principles of circuits in various embodiments of the invention.

The detailed description of the invention needs to be preceded by a reminder of the already-known techniques of (single or double) IQ and non-IQ sampling.

IQ sampling is a method commonly used for acquiring the parameters of RF signals (i.e. for demodulating them), and for performing digital processing on such parameters.

A modulated RF signal, written Y(t), may be expressed as follows:

Y(t)=A(t)×cos(ωt−φ(t))

where A(t) and φ(t) are respectively the instantaneous amplitude and phase, ω=2πf_{RF} is the angular frequency of the RF carrier of frequency f_{RF}, and time is designated by the variable t.

This signal may be resolved at any instant into its I and Q components using the following equivalence relationship:

$$Y ( t ) = A ( t ) \times cos ( ω t - ϕ ( t ) ) ⇔ \{ \begin{matrix}Y ( t ) = I ( t ) \times cos ( ω t ) + Q ( t ) \times sin ( ω t ) \\ I ( t ) = A ( t ) \times cos ( ϕ ( t ) ) \\ Q ( t ) = A ( t ) \times sin ( ϕ ( t ) )\end{matrix}$$

where I(t) and Q(t) are referred to respectively as the in-phase and quadrature components of the signal. Measuring, and thus knowing, I and Q is equivalent to knowing the amplitude and the phase of the observed signal, on the basis of the above equivalence relationships. It should be observed that other conventions are sometimes to be found in the literature for defining the components I and Q.

It is easily demonstrated that sampling the signal at the instants: ωt=0+2kπ, ωt=π/2+2kπ, ωt=π+2kπ, and ωt=3π/2+2kπ, provides directly and successively the values of I, Q, −I, −Q for k describing the set of natural integers.

From the values of I and Q as determined by sampling the signal, it is possible to calculate the amplitude and the phase by applying the following relationships:

$$\{ \begin{matrix}A = \sqrt{{I}^{2} + {Q}^{2}} \\ cos ( ϕ ) = \frac{I}{\sqrt{{I}^{2} + {Q}^{2}}} \\ sin ( ϕ ) = \frac{Q}{\sqrt{{I}^{2} + {Q}^{2}}}\end{matrix}$$

Numerically, given I and Q, it is possible to calculate A in several ways, and in particular by:

$$\{ \begin{matrix}A = \sqrt{{I}^{2} + {Q}^{2}} \\ ϕ = sign ( Q ) \times arccos ( \frac{I}{\sqrt{{I}^{2} + {Q}^{2}}} )\end{matrix}$$

or, in equivalent manner by:

$$\{ \begin{matrix}A = \sqrt{{I}^{2} + {Q}^{2}} & \\ ϕ = arcsin ( \frac{Q}{\sqrt{{I}^{2} + {Q}^{2}}} ) & if I > 0 \\ ϕ = sign ( Q ) \times π - arcsin ( \frac{Q}{\sqrt{{I}^{2} + {Q}^{2}}} ) & if I < 0\end{matrix}$$

Where sign(x) designates the following function: sign(x)=−1 for x<0 and sign(x)=+1 for x≧O.

Concerning the frequency of the sampling clock, which must be synchronous with the frequency of the RF carrier, it is possible to take any frequency fₛ such that:

$${f}_{s} = \frac{4}{( 2 k + 1 )} {f}_{RF} ,$$

with arbitrary positive integer k.

Depending on the values of k, the following are obtained in succession: I, Q, −I, −Q or I, −Q, −I, Q.

Techniques for performing IQ sampling and physical devices associated therewith are abundantly described in the literature, e.g in documents [6] and [7].

When this so-called single sampling method is applied, the time origin is set arbitrarily at the instant of one particular sample, and the phase of the signal is thus measured relative to the sampling clock. In certain circumstances, such as when controlling fields in multiple accelerator cavities of a particle accelerator, it is necessary to regulate the phase of the fields in each cavity relative to a reference that is common to all the cavities. This implies that the phase of the signal must be measured relative to the phase of the RF reference and thus that the sampling clock must be synchronous therewith. In practice, the frequencies of the RF reference and of the RF signal are in a simple (rational) relationship relative to each other, and the circuit that generates the sampling clock from the reference consists in a simple digital PLL or else is constituted by analog frequency dividers and multipliers. The general scheme for IQ demodulation by single sampling is given in FIG. 1, where:
Y(t) represents the RF signal to be demodulated (“main signal”);
R(t) represents the reference RF signal;
ADC is a unit comprising a sample-and-hold and analog-to-digital converter unit;
CC represents a circuit for generating a sampling clock signal HE that is synchronous with the reference signal (and thus with the carrier of the main signal Y); and
FPGA is a digital processor circuit that may specifically be an FPGA, or that may otherwise be a processor.

The problem with single sampling is that the phase of the RF signal is not measured directly relative to the RF reference, but relative to the sampling clock. If the clock-producing circuit drifts in phase, e.g. with temperature, then that drift is to be found fully in the measurement, which is not acceptable in applications where it is specifically desired to servo-control the phase of the observed signal to a constant value, as in particle accelerators.

A second problem lies in selecting the sample that is to be considered as the first value of I, which is equivalent to selecting the instant when t=0. If this selection is made arbitrarily, then from one measurement to the next phase is indeterminate, to within a multiple of π/2.

Those two problems are easily eliminated by double sampling, as is performed in numerous accelerators. See for example document [9].

Double IQ sampling consists in also sampling the RF reference at the same sampling frequency, and using the same clock. As shown in FIG. 2, a double sampling circuit has two sample-and-hold and analog-to-digital converter units ADC1 and ADC2. Such a circuit serves to measure the I_{RF} and φ_{RF} components of the RF signal, and also the reference components I_{REF} and φ_{REF}, each relative to the sampling clock. By applying the above formulae and by performing subtraction, it is thus possible to calculate the phase difference φ_{RF}−φ_{REF} where φ_{RF} is the phase of the main signal Y and φ_{REF} is the phase of the reference signal. This phase difference no longer depends on the phase drift of the sampling clock, nor does it depend on the instant 0 defining the beginning of acquisition.

In digital regulator systems, it may be advantageous to avoid converting into polar coordinates by remaining in the (I, Q) domain, mainly for reasons of speed of calculation or indeed to avoid the discontinuities that occur in ±π when applying formulae giving A and φ as a function of I and Q. By way of example, this may be done by applying the following formulae:

$$\{ \begin{matrix}I = \frac{( {I}_{RF} \times {I}_{REF} + {Q}_{RF} \times {Q}_{REF} )}{{A}_{REF}} \\ Q = \frac{( {Q}_{RF} \times {I}_{REF} - {I}_{RF} \times {Q}_{REF} )}{{A}_{REF}}\end{matrix}$$

where A_{REF} represents the amplitude of the reference. I and Q then represent the components of a signal having the same amplitude as the measured RF signal and having phase that is equal to the phase difference between the RF signal and the RF reference. In a manner equivalent to the above formulation, this measurement is thus unaffected both by phase drift of the sampling clock and by the selection of the instant t=0 at the beginning of acquisition.

It is possible to generalize the concept of IQ sampling and to speak of “synchronous” sampling. Synchronous sampling occurs when the sampling frequency is “synchronous” with the RF frequency of the signal of interest, in other words when f_{RF} and f_{S} are commensurable, i.e. when their ratio is a rational number:

$${f}_{s} = \frac{{N}_{1}}{{N}_{2}} {f}_{RF}$$

where N₁ and N₂ are natural integers. Under such circumstances, an angle α can be defined that corresponds to the phase difference between two successive samples:

$$α = 2 π \frac{{N}_{2}}{{N}_{1}}$$

During (single or double) sampling of the RF signal at a frequency such that consecutive samples are separated by an angle

$$α = ( 2 n - 1 ) \frac{π}{2}$$

with n being an arbitrary positive integer, the sampling is said to be IQ sampling. Otherwise the sampling is said to be “non-IQ” sampling. It should be observed that if:

$${f}_{s} = \frac{2}{N} {f}_{RF}$$

then it is not possible to determine the values of I and Q.

With non-IQ sampling, it is possible to find the values of I and Q from N samples of the signal, with N such that Nα is a multiple of 2π, by using the following equations:

$$I = \frac{2}{N} {\sum }_{i = 1}^{N} {x}_{i} cos ( i \times α )$$

$$Q = \frac{2}{N} {\sum }_{i = 1}^{N} {x}_{i} sin ( i \times α )$$

It is these equations that were used for performing the simulations of FIG. 6.

IQ sampling is by far the most commonly used, however under certain circumstances non-IQ sampling may be found advantageous, as described in document [8].

The mathematical description of synchronous IQ or non-IQ sampling as given above does not take account of the effect of the—inevitable—jitter in the sampling clock signal. In general, it may be considered that such jitter introduces an amplitude error δA and a phase error δφ in the derivation of the properties of the main signal.

The present inventor has found that these errors 6A and δφ depend on the phase of the radiofrequency signal(s), said phase being measured relative to the sampling clock signal, and more precisely relative to the initial instant t=0 as defined by the sampling clock. In particular, with single sampling, the errors δA and δφ depend on the phase of the main signal, while with double sampling these errors are a function of the phases of the main signal and of the reference signal.

FIGS. 3A and 3B show the results of simulations of IQ sampling of an RF signal at 1 GHz using a perfect 14-bit ADC but associated with a triggering clock that is subjected to jitter of 5 ps (Gaussian white noise). These graphs are the result of a Monte-Carlo simulation: each point represents a random draw of a signal of phase lying in the range −π to π, which is subjected to IQ sampling in order to measure its amplitude and its phase, which are then compared with their real values. The errors in measuring phase (FIG. 3A) and amplitude (FIG. 3B) are plotted up the ordinate axes of the graphs.

For a given phase (along the abscissa axis), the vertical dispersion of the simulation points is thus a representation of the measurement noise. The measurement errors simulated for a jitter of 100 femtoseconds (fs) are superposed (continuous line E_{100fs}). This jitter is of the same order of magnitude as the best aperture jitter specific to analog-to-digital coders (ADCs) that are to be found on the best-performance components present on the market: in other words, the line E_{100fs} represents the error that would be obtained if the jitter in the sampling clock signal were negligible. This makes it possible to visualize the extent to which a clock having jitter of 5 ps degrades measurement compared with what would be possible using a clock with jitter that is negligible but with a real ADC.

In FIG. 3B, it can be seen that the level of noise compared with the amplitude measurement varies extremely, depending on the phase of the measured signal. This noise is at a minimum for phases:

$${ϕ}_{RF} = \pm k \frac{π}{2}$$

(for integer k)
and it is at a maximum for phases:

$${ϕ}_{RF} = \frac{π}{4} \pm k \frac{π}{2}$$

For jitter that presents a Gaussian white noise characteristic of standard deviation σⱼᵢₜₜ, it can be shown that the maximum relative error on measurement by IQ sampling of the amplitude of an RF signal of frequency f in the presence of clock jitter of standard deviation σⱼᵢₜₜ is given in the vicinity of:

$$\frac{π}{4} \pm k \frac{π}{2}$$

(for integer k)
by:

$${σ ( \frac{Y - A}{A} )}_{max} ( rms ) = \sqrt{2} π f \times {σ}_{jitt}$$

(in radians)

Numerically, at 1 GHz, jitter of 5 ps rms produces measurement noise over an amplitude of about 2.22% rms. Under such conditions, in the vicinity of:

$$\pm k \frac{π}{2}$$

(for integer k)
the minimum relative amplitude error is given by:

$${σ ( \frac{Y - A}{A} )}_{min} = {( 2 \times π \times f \times {σ}_{jitt} )}^{2}$$

(in radians)

Numerically, at 1 GHz: jitter of 5 ps rms produces amplitude measurement noise of only about 0.1% rms.

Concerning phase measurement noise, FIG. 3A shows that the measurement noise due to the jitter of the clock varies with the phase of the signal, but with Gaussian jitter it can be shown that this variation is by a factor of \sqrt{2}, depending on phase.

The maximum phase measurement noise is obtained at the following phases:

$$\pm k \frac{π}{2}$$

(for integer k)
and is given by:

σ_{φ}=2π×f×σⱼᵢₜₜ (rad).

Numerically, for an RF signal at 1 GHz with jitter of 5 ps: σj_{φ}=1.8°, at the maximum.

The minimum phase measurement noise is obtained at phases of:

$$\frac{π}{4} \pm k \frac{π}{2}$$

(for integer k)
and is given by:

σ_{φ}=\sqrt{2}π×f×σⱼᵢₜₜ (rad.).

Numerically, for an RF signal at 1 GHz with jitter of 5 ps: σj_{φ}=1.27°, at the minimum.

FIGS. 3A and 3B show that by adjusting the phase of the signal (or in equivalent manner the phase of the conversion clock), e.g. with the help of a commercially available phase shifter, it is possible to make amplitude measurement noise negligible when performing measurement by single IQ sampling, and to reduce the phase measurement noise by about 40%.

FIG. 4 gives the phase error values derived from simulations similar to those performed for simple sampling, but this time for double sampling: simultaneous IQ sampling of an RF signal at 1 GHz and of an RF reference at the same frequency by means of two perfect 14-bit ADCs, using the same trigger clock subject to jitter of 5 ps. The phase of the RF reference relative to the sampling clock is 0°. The graph plots the measurement of the phase difference (φ_{RF}−φ_{REF}).

From this figure, it can be seen that with double IQ sampling, there exist phases of the RF signal for which the phase measurement noise becomes very small. These phases are phases close to kπ (for integer k). For these particular phases, the measurement noise is equivalent to the noise due to the jitter specific to the ADC, and it can be said that the measurement is unaffected by the jitter of the sampling clock. However, for amplitude error, going to double sampling does not give rise to any remarkable change of quality.

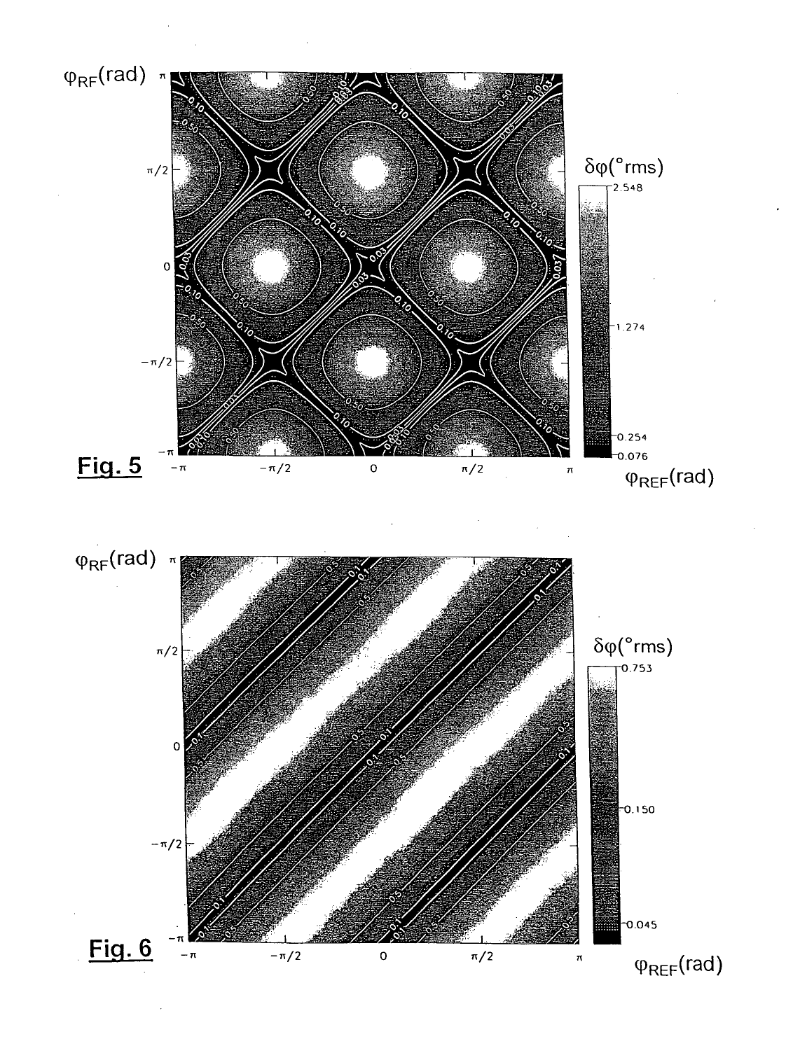

FIG. 5 shows the results of numerical simulation obtained by giving all possible values in the range −π to +π to the phases of the reference and of the signal. The jitter of the conversion clock is still 5 ps rms in the simulation; the aperture jitter of the ADCs is 100 fs rms; the sampled signals have an analog frequency of 1 GHz. FIG. 5 plots the phase difference measurement noise as measured by double IQ sampling as a function of the phase of the signal (up the ordinate axis) and the phase of the reference (along the abscissa axis). This rms noise is given in degrees at 1 GHz by the gray scale. In the diagram, outlines are shown that define the zones in which the values for measurement noise are less than the maximum noise by a factor of 2 (curves 0.5), of 10 (curves 0.1), and of 33 (curves 0.03).

FIG. 5 shows that with double sampling, it is possible to obtain phase measurements with very low noise, even when using a sampling clock that has a high level of jitter. If the phases of the signal and of the reference, φ_{RF} and φ_{REF}, are such that φ_{REF}=±φ_{RF}±kπ for integer k, then the effect of the clock jitter cancels, and measurement accuracy is limited only by other imperfections, such as the aperture jitter specific to the coder, or indeed the noise specific to the coder.

FIG. 6 corresponds to FIG. 5 for non-IQ double sampling with α=120°. It can be sent that in this mode, it is also possible to be unaffected by clock jitter, however here only for phases associated by the relationship: φ_{REF}=φ_{RF}±kπ.

The above simulations were all performed on the assumption that the jitter is Gaussian white noise. In reality, the jitter of digital components such as PLLs or indeed the digital clock managers (DCMs) of FPGAs is noise that is very highly correlated, in particular with low frequency components. It is possible to show that taking jitter correlation into account does not modify the above-described results in qualitative manner; merely the residual phase error is found to be even smaller. The idea on which the invention is based consists in adjusting the phase of the main signal and/or of the reference signal (when performing double sampling), in particular by means of phase shifters, in order to eliminate or reduce the effect of the jitter of the sampling clock. It is sufficient for the phase shifters to have an excursion of 180° (relative to the RF frequency of the signal of interest) in the general case in which the phases of the signals for processing are not known a priori.

By way of non-limiting example, document [10] describes analog phase shifters that are suitable for implementing the invention in certain frequency ranges.

Thus, a circuit of the invention may be obtained merely by adding one or more phase shifters to the circuit of FIG. 1 (single IQ or non-IQ sampling) or of FIG. 2 (double IQ or non-IQ sampling).

With double sampling, which is the most advantageous for reducing phase measurement noise, the analog RF signal Y(t) is sampled by the sample-and-hold and analog-to-digital converter unit ADC1. An analog reference signal R(t) having the same frequency as the RF signal for analysis is sampled by ADC2. The reference signal must suffer from phase noise that is as little as possible in order to achieve measurement accuracy that is as great as possible. In practice, it may for example be a signal delivered by a simple quartz oscillator or by a commercially-available synthesizer. Its phase noise will in any event be well below the phase noise of the sampling clock, the effects of which are to be reduced by the present invention.

The two coders ADC1 and ADC2 are triggered by the same sampling clock. It is assumed that this clock has jitter that is too great to obtain the desired accuracy in sampling the RF signal. Usually the sampling clock is synchronous with the reference signal, but that is not essential.

The IQ demodulation is performed on the basis of the digital signals generated by the ADCs, the processor, or the FPGA, which amounts to calculating the amplitude and the phase of the RF signal relative to the amplitude and the phase of the reference signal.

More generally, it is possible to use a reference signal R(t) having a frequency f_{REF} that is different from the frequency of the signal Y(t), but that is commensurable therewith, i.e. f_{REF}/f_{RF}=M₁/M₂ where M₁ and M₂ are non-zero natural integers. The main difference is that under such conditions, it is the error in the following measurement that is minimized:

$$( {ϕ}_{RF} - \frac{{f}_{RF}}{{f}_{REF}} {ϕ}_{REF} )$$

Depending on the demodulation algorithm used, it should be observed that it is also possible to calculate the amplitude of the RF signal without relating it to the amplitude of the reference signal, by using data from the ADC1 only in the calculation. If it is desired for example to apply the method to a particle accelerator, then it should be observed that the reference signal that is distributed in an accelerator is a signal that serves to synchronize the various subsystems, and it is thus a phase reference, but not necessarily an amplitude reference.

It should also be observed that sampling the RF reference with ADC2 makes it possible to be unaffected by any phase drift in the system that produces the sampling clock (CC), e.g. thermal drifts.

FIG. 8 shows possible locations for phase shifters PS1-PS7 that serve to modify the phase of one or more signals so as to move into one of the zones in which the effect of jitter is reduced as shown in FIG. 5 (or in FIG. 6 if non-IQ double sampling is being performed). With single sampling, the possible locations of the phase shifter(s) are referenced PS1, PS3, PS4, and PS6.

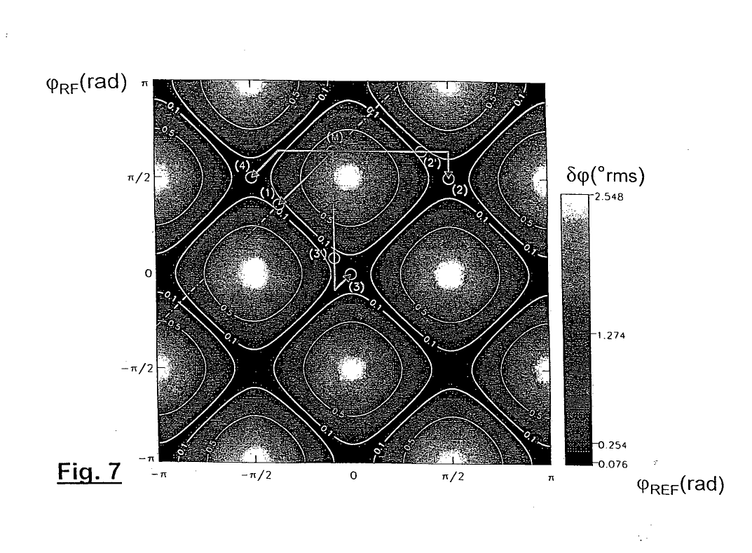

FIG. 7 serves to understand how these phase shifters act. In FIG. 7, the point (M) represents the starting situation: the phases φ_{RF} and φ_{REF} are random values, φ_{RF}=115° and φ_{REF}=−15°, corresponding to a high level of phase error.

The simplest solution consists in using a single phase shifter: with IQ sampling, this always makes it possible to reach an operating point where the measurement noise is lower, in one of the “valleys” of the diagrams of FIGS. 5 and 7.

For example, the use of a single phase shifter PS3 or PS4 makes it possible to move diagonally in the diagram of FIG. 7 from the point (M) to the point (1). The use of a single phase shifter PS2 or PS7 makes it possible to move horizontally in the diagram of FIG. 7 from the point (M) to the point (2′). Whereas the use of a single phase shifter PS1, PS5, or PS6 makes it possible to move vertically, from the point (M) to the point (3′).

The use of a single phase shifter PS4 may be particularly advantageous when the sampling clock is generated by a digital circuit such as the DCM of an FPGA, since under such circumstances the phase shifter may already be integrated in the circuit, as applies to a Virtex-5 from Xilinx. It is thus possible to adjust phase without any need to incorporate an additional component in the measurement and processing electronics.

The drawback of using only one phase shifter is that, in the general case, the “valley” that is reached is narrow: the measurement noise is small so long as the phase shifter is perfectly adjusted, but it will degrade quickly with very little misadjustment. It will also be difficult to achieve optimum adjustment if the phase shift introduced by the phase shifter varies in discrete steps. For example, the individual stepsize of programmable phase shifting is 1.46 ns in a Virtex-5 FPGA generating a sampling clock at 266 megahertz (MHz) on a PLL output, i.e. 5.3° of phase for an RF signal at 1 GHz.

It should be emphasized that using phase shifters at the locations PS6 and PS7 is possible, but not recommended, since such devices are each likely to add a contribution to jitter, which will not be in common with the clocks reaching the two ADCs, so the effects thereof cannot be reduced by the device.

Observing FIGS. 5 and 7 shows that of all possible adjustments corresponding to the relationship φᵣ=±φₛ±kπ, certain operating points are more advantageous than others. There exist zones of small phase error that are quite wide around the points:

$$\{ \begin{matrix}{ϕ}_{RF} = 0 \pm k \frac{π}{2} , \\ {ϕ}_{REF} = \pm {ϕ}_{RF} \pm k π\end{matrix}$$

with arbitrary integer k

In addition, these operating points correspond to phase values of the “main” signal for which the amplitude measurement noise is at a minimum.

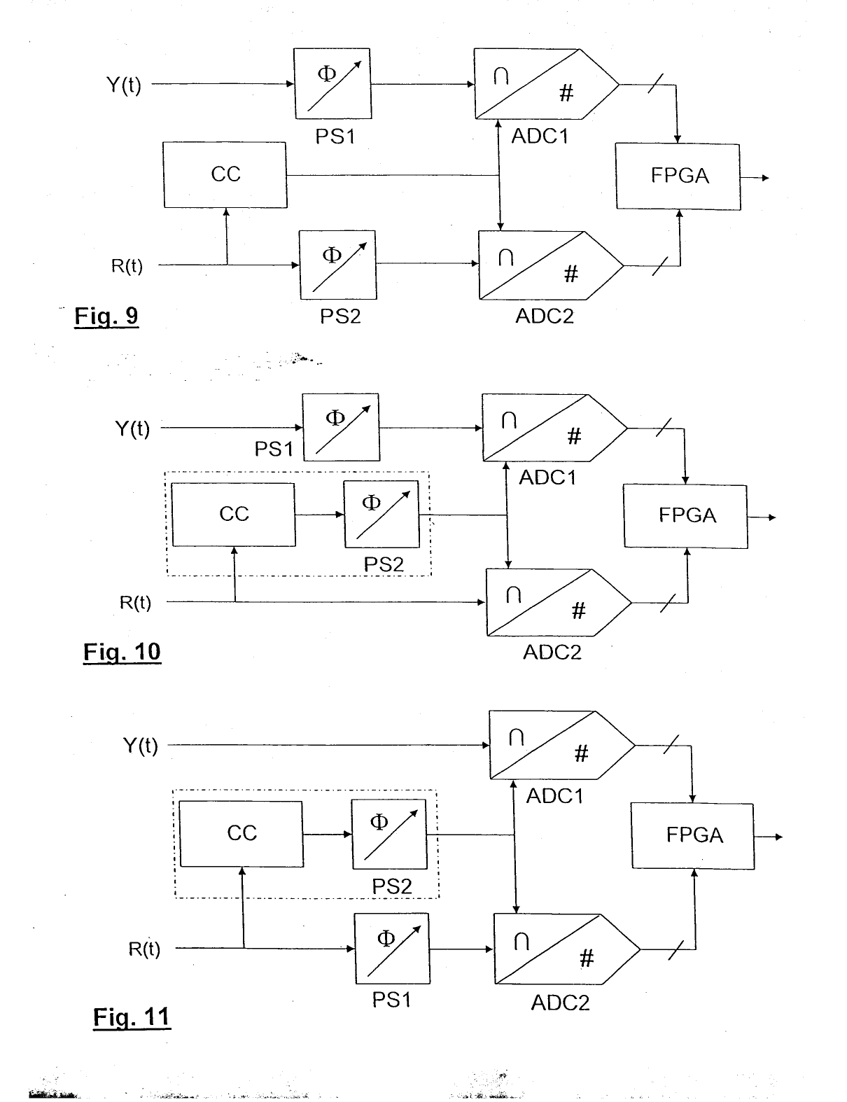

By way of example, these are the points (2), (3), and (4) in FIG. 7. In general, in order to reach these points from an arbitrary starting point (M), it is necessary to have at least two phase shifters in order to introduce a phase shift that is independent of the main signal and of the reference signal. This result may be obtained by using a first phase shifter on the path of the main signal and a second phase shifter on the path of the reference signal (see FIG. 9); or it is possible to use a first phase shifter on the path of the sampling signal (thereby introducing a phase shift in both signals for sampling, of phases that are defined in particular relative to the sampling clock signal), and a second phase shifter on the path of the main or the reference signal (see FIGS. 10 and 11).

For example, the point (2) is reached by combining a horizontal movement (phase shifter PS2 or—but this is not recommended—PS7) and a vertical movement (phase shifter PS1, PS5 or—but this is not recommended—PS6). The point (3) may be reached by combining a vertical movement and a diagonal movement (PS3 or PS4). The point (4) may be reached by combining a horizontal movement and a diagonal movement.

In practice, it is possible for example to adopt the circuit of FIG. 9, of FIG. 10, or of FIG. 11, thus making it possible to reach the zones (2), (3), or (4) respectively from the starting point (M) of FIG. 7, by traveling along the specific paths.

The circuits of FIGS. 10 and 11 are particularly advantageous since PS2 may be a digital phase shifter that is already integrated in the circuit for producing the sampling clock, for example if it is the DCM of an FPGA. Implementation of the invention then requires only one component to be added, an analog phase shifter on the main measurement path (FIG. 10) or else on the RF reference measurement path (FIG. 11). An advantage of the circuit of FIG. 10 is that, starting from an initial adjustment, it suffices to control solely the phase shifter PS1 in order to keep the measurement at its optimum. Only the phase of the RF signal of interest is likely to vary. An advantage of the configuration of FIG. 11 is that no additional component is introduced in the main measurement path. However, when the phase of the RF signal of interest varies, it is necessary to adjust both phase shifters PS1 and PS2 if it is desired to remain in the vicinity of a point such as one of the points (2), (3), or (4) in FIG. 7.

FIG. 6 shows that with non-IQ synchronous sampling there do not exist any particular operating points having greater adjustment stability, as occurs with IQ sampling. Under such conditions, there is no point in having two phase shifters. A single phase shifter that makes it possible to move vertically or horizontally in FIG. 6 enables the noise on the phase measurement to be optimized. The possible locations are PS1, PS2, PS5, PS6, and PS7, in the circuit of FIG. 8. For non-IQ double sampling, when the main signal and the reference signal are both of the same frequency, the locations PS3 and PS4 for the phase shifters are of no advantage from the present point of view: any action thereon would give rise to movement along a straight line parallel to the line φ_{REF}=φ_{RF} in the diagram of FIG. 6, which would not have any affect on measurement noise.

It should be observed that when performing non-IQ sampling, the “valleys” are always quite narrow. Thus, from the point of view of adjustment stability, IQ sampling is better.

In order to operate in optimum manner, the method generally assumes that the phase difference between the RF signal and the RF reference varies little so that it remains in a zone of small phase error. In practice, in the general case, it can thus be imagined that the phase shifters used are servo-controlled so as to comply with this condition, tracking the changes in the phase of the RF signal of interest. In the circuit of FIG. 8, the reference AS indicates such a servo-control device. In practice, it may be the same processor or FPGA as is used for demodulating the signal.

Nevertheless, there exist certain particular applications in which such servo-control is not necessary, thereby simplifying the implementation of a demodulator of the invention. This applies in particular to controlling RF fields in the cavities of particle accelerators. The purpose of the RF electronics controlling such accelerators is specifically to make it possible in each cavity to servo-control its field to given amplitude and phase, with the phase being relative to a reference signal that is used for synchronizing all of the pieces of equipment. In other words, in a given mode of operation of the accelerator, each cavity is the seat of an RF field that presents phase and amplitude that are constant relative to the reference signal. It is thus possible to adjust the phase shifter(s) so as to minimize the measurement noise due to clock jitter and to keep these adjustments constant in order for the accelerator to operate in this mode.

### REFERENCES

[1] Brad Brannon, Sampled Systems and the Effects of Clock Phase Noise and Jitter, Analog Devices Application Note AN-756, 2004.
[2] Tina Harriet Smilkstein, Jitter Reduction on High-Speed Clock Signals, Technical Report No. UCB/EECS-2007-96, University of California at Berkeley.
[3] S. N. Simrock, Low Level Radio Frequency control system for the european XFEL, MIXDES 2006, Gdynia, Poland, Jun. 22-24, 2006.
[4] P. de Antoni, P. Galdemard, O. Piquet, S. Sube, Y. Mariette, M. Luong, M. Di Giacomo, The architecture of the low level RF electronics for Spiral 2, Low Level Radio Frequency Workshop, Oct. 22-25, 2007—Knoxville, Tenn., USA.
[5] Method and apparatus for analog-to-digital conversion by combining digital sample values, U.S. Pat. No. 6,317,071.
[6] M. Grecki, T. Jezynski, A. Brandt, Estimation of IQ vector components of RF field—Theory and implementation, MIXDES 2005, Krakow, Poland, Jun. 22-25, 2005.
[7] Subharmonic quadrature sampling receiver and design, U.S. Pat. No. 5,937,013.
[8] L. Doolittle, H. Ma, M. S. Champion, Digital low-level RF control using non-IQ sampling, Proceedings of LINAC 2006, Knoxville, Tenn. USA.
[9] L. Doolittle, Low-Level RF Control System Design And Architecture, Proceedings of APAC 2007, Indore, India.
[10] Analog Phase Shifter Using Cascaded Voltage Tunable Capacitor U.S. Pat. No. 7,276,993.

1. A method of demodulating a radiofrequency signal (Y), the method comprising the steps consisting in:
providing a sampling clock signal (HE) that is synchronous with said radiofrequency signal for demodulating;
sampling said radiofrequency signal by means of said sampling clock signal; and
processing the samples obtained in this way to determine the phase and/or the amplitude of said radiofrequency signal;
the method being characterized in that it also includes a step of adjusting the phase, measured relative to the sampling clock signal, of said signal for demodulating and/or of a synchronous reference signal (R) relative to which said signal is demodulated, in such a manner as to minimize the phase and/or amplitude error caused by jitter of said signal clock signal.

2. A method according to claim 1, wherein said radiofrequency signal presents a carrier at the frequency f_{RF} and wherein said sampling clock signal presents a frequency f_{S}=N₁/N₂·f_{RF} where N₁ and N₂ are different natural integers such that there does not exist any non-zero natural integer N₃ for which N₁/N₂=2/N₃.

3. A method according to claim 2, wherein said sampling clock signal presents a frequency f_{S}=4/(2k+1)·f_{RF}, where k is a natural integer, whereby said sampling is IQ-type sampling.

4. A method according to claim 2, wherein said sampling clock signal presents a frequency f_{S}=N₁/N₂·f_{RF}≠4(2k+1)·f_{RF} where k is a natural integer, whereby said sampling is non-IQ type sampling.

5. A method according to claim 2, wherein the phase of said radiofrequency signal as measured relative to the sampling signal is adjusted to a value that is as close as possible to a target value selected from:
±kπ/2 for integer k, so as to minimize the amplitude measurement error caused by jitter of said sampling clock signal; and
π/4±kπ/2 for integer k, so as to minimize the phase measurement error caused by the jitter of said sampling clock signal.

6. A method according to claim 3, comprising IQ sampling of said radiofrequency signal that is referred to as the main signal (Y), and of a second radiofrequency signal (R) that is synchronous with said main signal and that is referred to as the reference signal, and processing samples as obtained in this way to determine the phase variations of said main signal relative to said reference signal, wherein the phase φ_{RF} of the carrier of said main signal and the phase φ_{REF} of said reference signal are adjusted in such a manner as to minimize the error in the measurement of:
$$( {ϕ}_{RF} - \frac{{f}_{RF}}{{f}_{REF}} {ϕ}_{REF} )$$
where f_{REF} is the frequency of the reference signal, which frequency is commensurable with the frequency of the main signal.

7. A method according to claim 6, wherein the phase φ_{RF} of said main signal and the phase φ_{REF} of said reference signal are adjusted in such a manner as to come as close as possible to the relationship φ_{REF}=±φ_{RF}±kπ with integer k.

8. A method according to claim 7, wherein the phase φ_{RF} of said main signal and the phase φ_{REF} of said reference signal are adjusted in such a manner as to come as close as possible to the following relationships:
φ_{RF}=±kπ/2 and φ_{REF}=±φ_{RF}±k′π
and
φ_{REF}=±φ_{REF}±k′π
with integer k and k′.

9. A method according to claim 4, including non-IQ sampling of a first radiofrequency signal (Y) that is referred to as the main signal, and of a second radiofrequency signal (R) that is synchronous with said main signal and that is referred to as the reference signal, and processing samples as obtained in this way to determine the phase variations of said main signal relative to said reference signal, wherein the phase φ_{RF} of the carrier of said main signal and the phase φ_{REF} of said reference signal are adjusted in such a manner as to minimize the error in the measurement of the magnitude:
$$( {ϕ}_{RF} - \frac{{f}_{RF}}{{f}_{REF}} {ϕ}_{REF} )$$
where f_{REF} is the frequency of the reference signal, which frequency is commensurable with the frequency of the main signal.

10. A method according to claim 9, wherein the phase φ_{RF} of said main signal and the phase φ_{REF} of said reference signal are adjusted in such a manner as to come as close as possible to the relationship φ_{REF}=±φ_{RF}±kπ with integer k.

11. A method according to claim 6, wherein the carrier of said main signal and said reference signal are at the same frequency.

12. A method according to claim 1, wherein said phase adjustment is obtained by means of at least one phase shifter (PS1-PS7).

13. A method according to claim 12, wherein said phase adjustment is obtained by means of at least two phase shifters for introducing independent phase shifts of said main signal and of said reference signal.

14. A demodulator circuit comprising:
a first input for a radiofrequency signal (Y) for demodulating;
a generator (CC) for generating a sampling clock signal (HE) that is synchronous with said radiofrequency signal;
a first sampler (ADC1) for sampling said radiofrequency signal under the control of said sampling clock signal; and
processor means (FPGA) for processing samples as obtained in this way in order to determine the phase and/or the amplitude of said radiofrequency signal;
the circuit being characterized in that it includes at least one adjustable phase shifter (PS1-PS7) for shifting said radiofrequency signal, a synchronous reference signal (R) relative to which said signal is demodulated, and/or said sampling clock signal (HE).

15. A circuit according to claim 14, also including:
an input for a second radiofrequency signal (R) referred to as the reference signal; and
a second sampler (ADC2) controlled by said sampling clock signal in order to sample said reference signal;
wherein said sample processor means are adapted to determine phase information relating to said main signal relative to said reference signal on the basis of samples provided by said first and second samplers.

16. A circuit according to claim 15, wherein said sampling clock signal generator (CC) is controlled by said reference signal.

17. A circuit according to claim 15, also including control means (AS) for adjusting said or each phase shifter in such a manner as to maintain the phase and/or the phase difference of said main signal and of said reference signal within a predetermined range of values.

18. A circuit according to claim 15, including at least two phase shifters designed to introduce independent phase shifts of said main signal and of said reference signal.
